(19) United States
(12) Patent Application Publication
(10) Pub. No.: US 2009/0060603 A1
(43) Pub. Date: Mar. 5, 2009

(54) IMAGE FORMING APPARATUS AND IMAGE FORMING METHOD

(75) Inventor: Masahiro DOI, Tagata-gun (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/201,940

(22) Filed: Aug. 29, 2008

Related U.S. Application Data
(60) Provisional application No. 60/969,590, filed on Aug. 31, 2007.

(51) Int. Cl. G03G 21/00

(52) U.S. Cl. 399/358

(57) ABSTRACT

A waste-toner transferring device that transfers a waste toner to a waste-toner collecting unit have a first auger transfer unit arranged vertically and a second auger transfer unit that supplies the waste toner to the first auger transfer unit, wherein the first and second auger transfer units respectively have casings provided with inlets and outlets for the waste toner and augers rotatable around shafts arranged along a transfer direction in the casings, and auger vanes are not provided in a predetermined range of the auger arranged in a portion of the outlet of the second auger transfer unit, the predetermined range being narrower than the width of the inlet of the first auger transfer unit.

### CROSS-REFERENCE TO RELATED APPLICATION

This application claims the benefit of U.S. Provisional Application No. 60/969,590, filed Aug. 31, 2007.

### TECHNICAL FIELD

The present invention relates to a waste toner transfer mechanism for collecting used waste toner in a copying machine, a printer, and the like of an electrophotographic system for transferring a toner to obtain an image, and, more particularly to an image forming apparatus and an image forming method including the waste toner transfer mechanism.

### BACKGROUND

In image forming apparatuses such as a copying machine and a printer, a toner remaining on a secondary transfer roller, which has finished secondary transfer, is removed by a cleaning device. The residual toner removed from the secondary transfer roller is transferred to a waste toner box by a waste toner transfer mechanism.

Conventionally, there is known a method of using a transfer screw or an auger as means for transferring a waste toner to a waste toner box (JP-A-2005-84553).

### SUMMARY

A waste-toner transferring device according to a first aspect of the present invention is a waste-toner transferring device that transfers a waste toner to a waste-toner collecting unit, the waste-toner transferring device having a first auger transfer unit arranged vertically and a second auger transfer unit that supplies the waste toner to the first auger transfer unit, wherein the first and second auger transfer units respectively have casings provided with inlets and outlets for the waste toner and augers rotatable around shafts arranged along a transfer direction in the casings, and auger vanes are not provided in a predetermined range of the auger arranged in a portion of the outlet of the second auger transfer unit, the predetermined range being narrower than the width of the inlet of the first auger transfer unit.

An image forming apparatus according to a second aspect of the present invention has an image transferring unit that transfers a reverse image based on a scanned original image onto an image bearing member as a toner image, a secondary transfer roller that comes into contact with the image bearing member and transfers the toner image onto a recording medium, a cleaning device that removes a residual toner on the secondary transfer roller as a waste toner, and a waste-toner transferring device that transfers the removed waste toner to a waste toner collecting device, wherein the waste-toner transferring device has a first auger transfer unit arranged vertically and a second auger transfer unit that supplies the waste toner to the first auger transfer unit, the first and second auger transfer units respectively have casings provided with inlets and outlets for the waste toner and augers rotatable around shafts arranged along a transfer direction in the casings, and auger vanes are not provided in a predetermined range of the auger arranged in a portion of the outlet of the second auger transfer unit, the predetermined range being narrower than the width of the inlet of the first auger transfer unit.

An image forming method for an image forming apparatus having an image transferring unit configured to transfer a reverse image based on a scanned original image onto an image bearing member as a toner image, a secondary transfer roller that comes into contact with the image bearing member and transfers the toner image onto a recording medium, a cleaning device that removes a residual toner on the secondary transfer roller as a waste toner, and a waste-toner transferring device that transfers the removed waste toner to a waste toner collecting device, the method comprising; arranging vertically a first auger transfer unit that is provided in the waste-toner transferring device, and arranging a second auger transfer unit that supplies the waste toner to the first auger transfer unit, wherein the first and second auger transfer units respectively have casings provided with inlets and outlets for the waste toner and augers rotatable around shafts arranged along a transfer direction in the casings, and auger vanes are not provided in a predetermined range of the auger arranged in a portion of the outlet of the second auger transfer unit, the predetermined range being narrower than the width of the inlet of the first auger transfer unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram of an image forming unit of an image forming apparatus according to a first embodiment of the present invention;

FIG. 2 is a perspective view showing a configuration of a secondary transfer unit;

FIG. 3 is a side view of the secondary transfer unit;

FIG. 4 is a diagram showing a path for transferring a waste toner to a waste toner box;

FIG. 5 is a diagram showing the intra-unit waste toner box with a part of a side thereof cut away;

FIG. 6 is a diagram showing an auger;

FIG. 7 is a diagram showing the structure of a second waste toner transfer unit according to the embodiment;

FIG. 8 is a perspective view showing a bush attached with an oil seal;

FIG. 9 is a sectional view along an axial direction of the auger showing a shape of vanes of the auger;

FIG. 10 is a sectional view along the axial direction of the auger showing a shape of vanes of the auger;

FIG. 11 is a diagram showing an example of a configuration of the image forming apparatus according to this embodiment; and

FIG. 12 is a diagram showing an example of a configuration of the image forming apparatus according to this embodiment.

### DETAILED DESCRIPTION

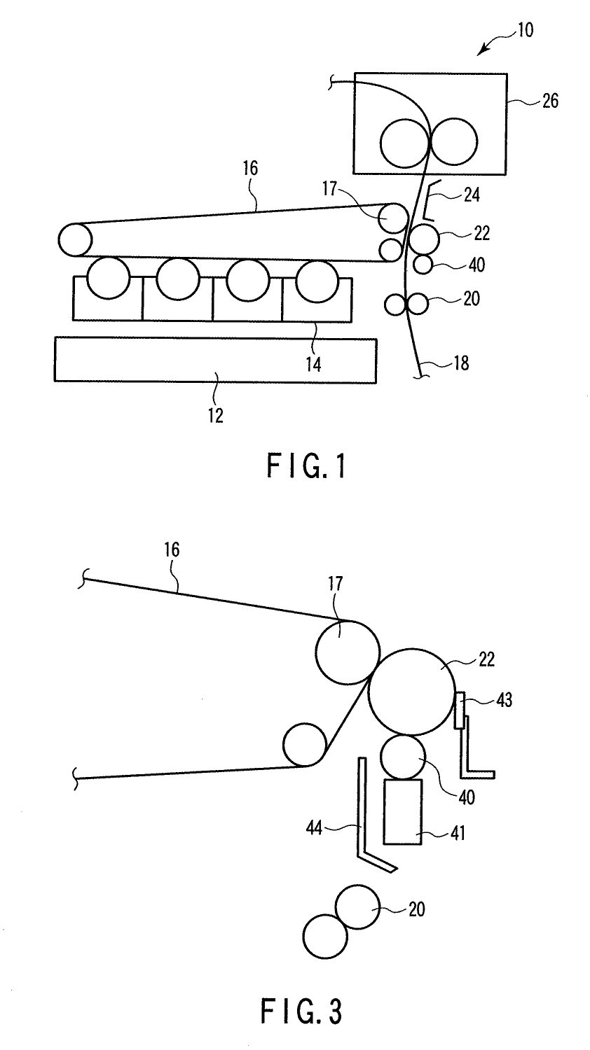

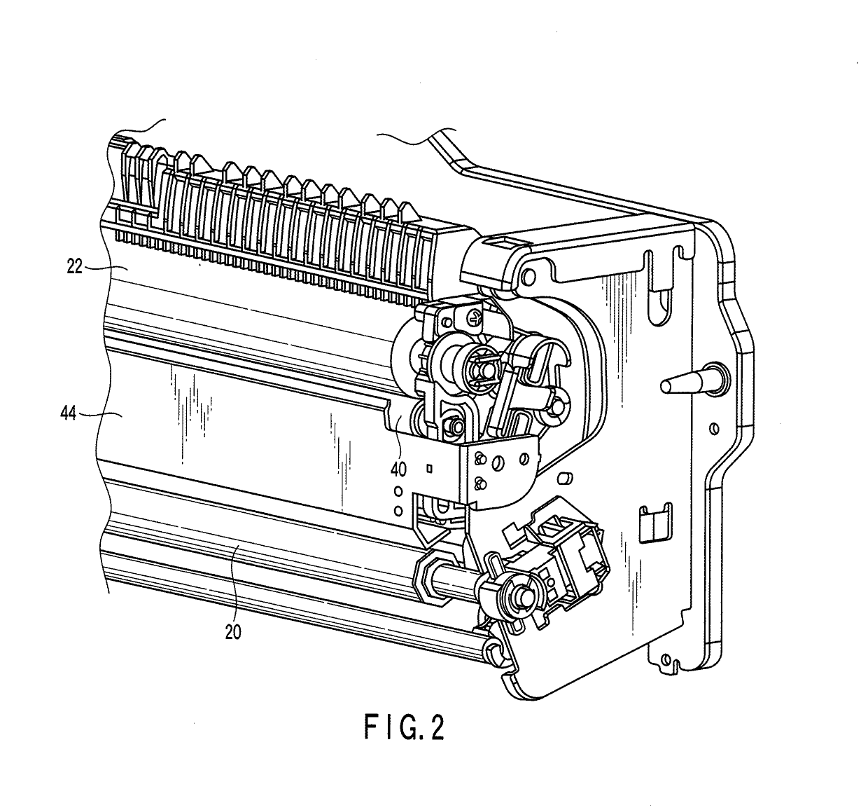

FIG. 1 is a schematic diagram of an image forming unit of an image forming apparatus according to an embodiment of the present invention. FIG. 2 is a perspective view showing a configuration of a secondary transfer unit. FIG. 3 is a side view of the secondary transfer unit.

As shown in FIG. 1, an image forming unit 10 includes a laser unit 12, developing devices 14, a transfer belt (an image bearing member) 16, a counter roller 17, a sheet conveying path 18, registration rollers 20, a secondary transfer roller 22, a fur brush 40, a conveyance guide 24, and a fixing device (a fixing unit) 26.

The laser unit 12 irradiates a laser beam optically modulated according to an image signal of an original scanned by a not-shown scanner unit or an image signal inputted from an external apparatus on the developing devices 14 and forms electrostatic latent images on the developing devices 14. The developing devices 14 reversely develop the electrostatic latent images and transfer toner images onto the transfer belt 16.

The sheet conveying path 18 is a conveying path for a sheet fed from a not-shown paper feeding unit. The registration rollers 20 correct the inclination of the sheet immediately before an image is transferred onto the sheet. The secondary transfer roller 22 is arranged downstream of the registration rollers 20 to be opposed to the counter roller 17 and capable of coming into contact with the transfer belt 16. When the sheet passes between the transfer belt 16 and the secondary transfer roller 22, the toner images are collectively transferred onto the sheet. The conveyance guide 24 guides the sheet conveyed out from the secondary transfer roller 22 to the fixing device 26. The fixing device 26 fixes the images, which are transferred onto the sheet by the secondary transfer roller 22, on the sheet.

As shown in FIGS. 2 and 3, a fur brush 40 and a lubricant case 41 that is pressed against the fur brush 40 and supplies a lubricant (zinc stearate) thereto are provided below the secondary transfer roller 22. A cleaning blade 43 that scrapes off a residual toner adhering to the secondary transfer roller 22 is in contact with the secondary transfer roller 22. A pre-transfer guide 44 is fixedly provided between the fur brush 40 and the lubricant case 41 and the sheet conveying path 18.

A consumable unit 45 is provided on the opposite side of the secondary transfer roller 22 with respect to the pre-transfer guide 44. The residual toner (hereinafter referred to as waste toner) collected by the cleaning blade 43 is accumulated in an intra-unit waste toner box 46 (not shown) provided in the consumable unit 45.

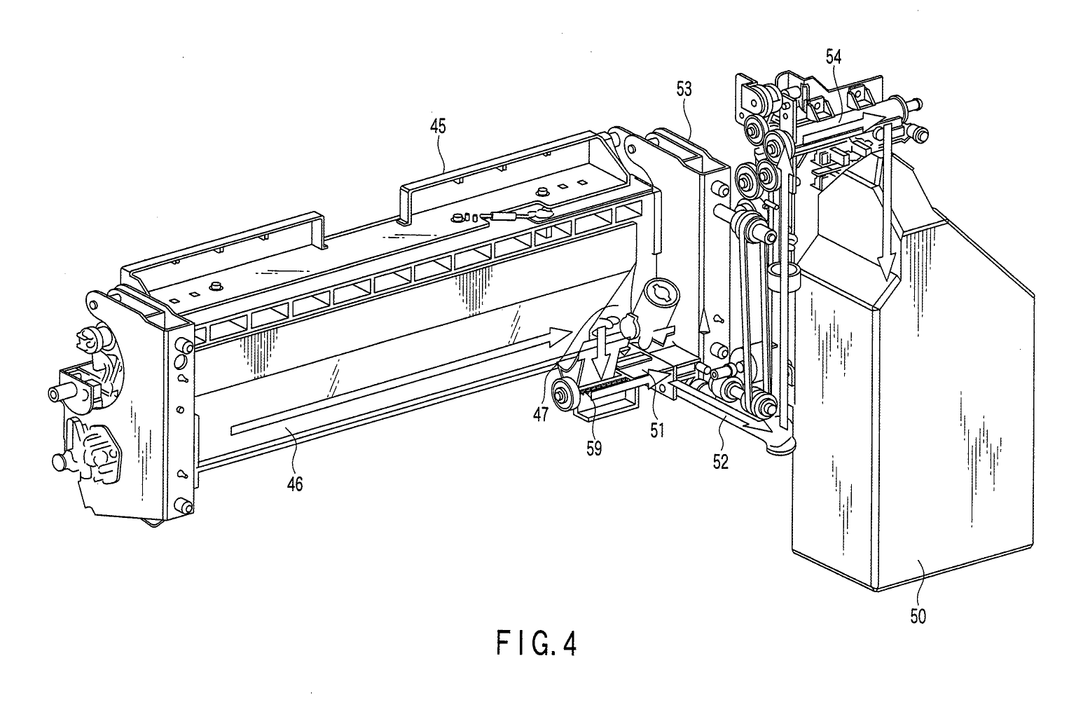

FIG. 4 is a diagram showing a path for transferring the waste toner to the waste toner box 50. In FIG. 4, the consumable unit 45 is shown from a direction opposite to that shown in FIG. 2.

The waste toner accumulated in the intra-unit waste toner box 46 is transferred through a path formed by a first waste-toner transfer unit 51, a second waste-toner transfer unit 52, a third waste-toner transfer unit 53, and a fourth waste-toner transfer unit 54 and falls and flows into the waste toner box 50.

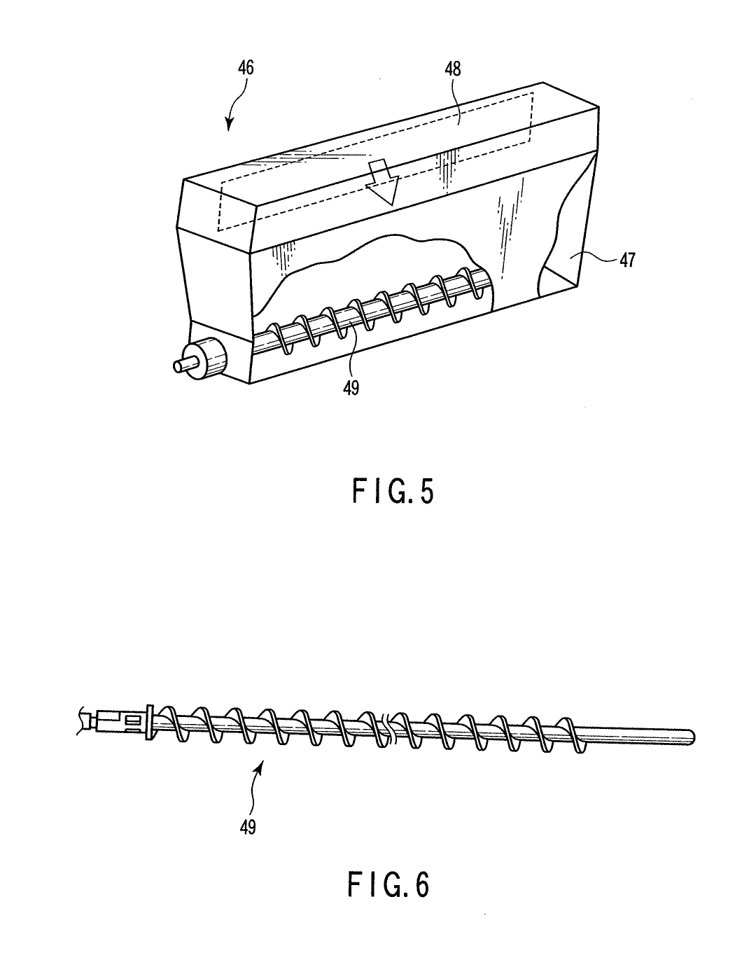

FIG. 5 is a diagram showing the intra-unit waste toner box 46 with a part of a side thereof cut away. The waste toner scraped off by the cleaning blade 43 falls into the intra-unit waste toner box 46 from an opening 48 provided on a rear side thereof and is accumulated in the intra-unit waste toner box 46. On the other hand, an auger 49 shown in FIG. 6 is disposed in the intra-unit waste toner box 46. In the auger 49, a member is spirally provided around one shaft. According to the rotation of the shaft, the waste toner is transferred in a linear direction along the shaft, free-falls from an outlet 47 provided at an end of the intra-unit waste toner box 46, and is received by the first waste-toner transfer unit 51.

The first waste-toner transfer unit 51, the second waste-toner transfer unit 52, the third waste-toner transfer unit 53, and the fourth waste-toner transfer unit 54 include augers 59 therein, respectively, and pass the waste toner at joints of the respective transfer units and transfer the waste toner.

It is pointed out that, usually, when the waste toner is transferred by using augers, clogging of the waste toner occurs because the waste toner is not smoothly passed at the joints of the transfer units. In particular, when the waste toner is transferred not only in the horizontal direction but also obliquely upward, the waste toner is less easily transferred and stagnates when the waste toner is transferred obliquely upward. Failures such as insufficient supply and clogging of the waste toner tend to occur.

In this embodiment, the third waste-toner transfer unit 53 is provided vertically. In this configuration, it is likely that a large amount of waste toner stagnates compared with the time when the waste toner is transferred obliquely upward as in the past.

The inventor performed an investigation concerning the stagnation of the waste toner caused by providing the third waste-toner transfer unit 53 vertically and obtained knowledge described below.
(1) A position where the waste toner stagnated was a portion where the waste toner was passed from the second waste-toner transfer unit 52 as a horizontal transfer mechanism to the third waste-toner transfer unit 53 as a vertical transfer mechanism. The waste toner did not stagnate in a portion where the waste toner was passed from the third waste-toner transfer unit 53 as a vertical transfer mechanism to the fourth waste-toner transfer unit 54 as a horizontal transfer mechanism.
(2) The waste toner leaked from an end that was provided on an exit side of the second waste-toner transfer unit 52 and supported a center shaft of the auger 59.
(3) A phenomenon in which the waste toner adhered on the exit side of the second waste-toner transfer unit 52 also occurred.
(4) The waste toner leaked from an end that was provided below the third waste-toner transfer unit 53 and supported the center shaft of the auger 59.

From the knowledge, it is assumed that a phenomenon described below occurs concerning the stagnation of the waste toner.

Usually, when plural auger transfer mechanisms are combined, the auger transfer mechanisms are designed such that transfer speed of a transfer unit provided downstream is larger than transfer speed of a transfer unit provided upstream. This is for the purpose of preventing the waste toner from stagnating while the waste toner is transferred.

The waste toner appropriately transferred in the mechanism for horizontally transferring the waste toner stagnates when the mechanism for vertically transferring the waste toner is provided. Therefore, it can be surmised that transfer efficiency falls in the transfer unit disposed vertically. A cause of the fall in the transfer efficiency is surmised as described below.

In an auger transfer mechanism, a gap is provided between a casing and vanes. Therefore, the waste toner in the gap is not transferred and stagnates in the casing. When the auger transfer mechanism is disposed horizontally, the waste toner stagnates in the gap in a lower part of the casing. On the other hand, when the auger transfer mechanism is disposed vertically, the waste toner falls from the gap between the casing and the vanes around the casing.

It is surmised that, as a result, the waste toner falling from the gap deposits at a lower end of the third waste-toner transfer unit 53 and the leakage of the waste toner described (4) above occurs. In the third waste-toner transfer unit 53, although the transfer efficiency falls, a transfer function is not spoiled. Therefore, the waste toner is transferred as time elapses.

However, since the waste toner falling to the lower end of the third waste-toner transfer unit 53 deposits, the waste toner is hindered from being transferred on the exit side of the second waste-toner transfer unit 52. In other words, the waste toner is pressed against the exit side of the second waste-toner transfer unit 52. It is surmised that, as a result, the leakage of the waste toner and the adhesion of the waste toner described in (2) and (3) above occur. Therefore, to allow the transfer mechanism including the third waste-toner transfer unit 53 disposed vertically to continue to normally operate, it is necessary to prevent the leakage of the waste toner and the adhesion of the waste toner on the exit side of the second waste-toner transfer unit 52. It is also necessary to prevent the leakage of the waste toner from the lower end of the third waste-toner transfer unit 53.

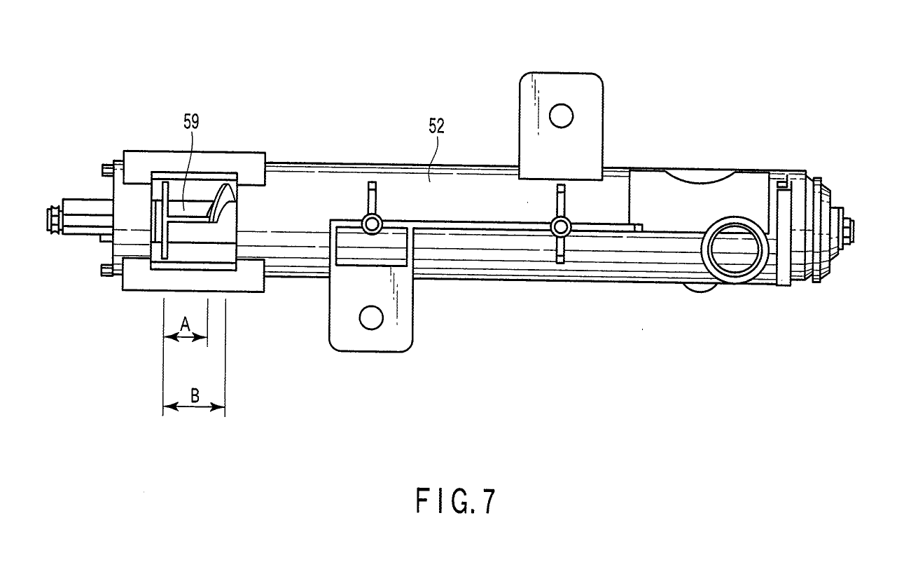

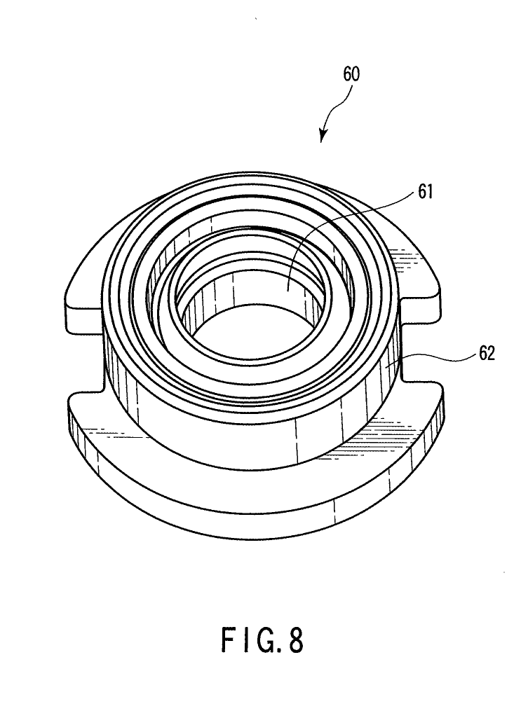

FIG. 7 is a diagram showing the structure of the second waste-toner transfer unit 52 according to this embodiment. An opening (not shown) for receiving the waste toner is provided on a right side of the figure. An opening for discharging the waste toner is provided on a left wide of the figure. A cutout range (A) in which auger vanes are not provided is formed in an exit side portion of the auger 59. In the past, since such a cutout range (A) was not formed, the waste toner was transferred to a left end of the figure and pressed by the auger 59 and stagnated. This is considered to be a main cause of the leakage of the waste toner and the adhesion of the waste toner. Therefore, a force for pressing the waste toner can be relaxed by providing the cutout range (A) in the auger 59. Therefore, it is possible to reduce the occurrence of the leakage of the waste toner and the adhesion of the waste toner.

In FIG. 7, an opening range (B) of an entrance of the third waste-toner transfer unit 53 is also clearly shown. To cause the cutout range (A) to display an effect thereof, the cutout range (A) is provided in a range smaller than the opening range (B) of the entrance. Moreover, the cutout range (A) is desirably provided in a range longer than intervals of the vanes.

Furthermore, in this embodiment, a sealing mechanism is strengthened in order to prevent the waste toner from leaking from the end of the auger 59. Specifically, a bush 60 attached with an oil seal is used as a bush on a side of the second waste-toner transfer unit 52 to which the waste toner is sent and a bush below the third waste-toner transfer unit 53.

FIG. 8 is a perspective view showing the bush 60 attached with the oil seal. Grease is applied to an inner diameter portion 61 and a cylindrical fitting portion 62 of the auger 59, whereby the bush 60 prevents the leakage of the waste toner. The bush 60 can also prevent peeling of a seal when the auger 59 is attached.

From the viewpoint of reducing the stagnation of the waste toner, it is desirable to configure the respective transfer unit 52 and 53 as described above and take measures for improving the transfer efficiency of the third waste-toner transfer unit 53. For example, as measures for increasing a transfer amount of the waste toner per unit time, rotating speed of the center shaft of the auger 59 may be increased. A shape of the vanes may be changed.

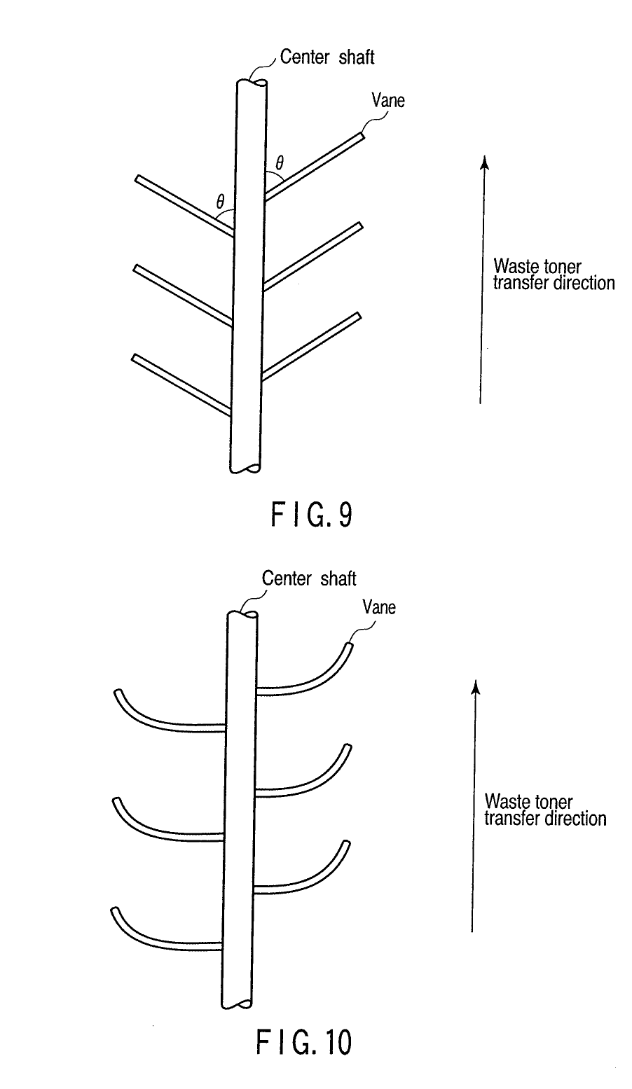

FIGS. 9 and 10 are sectional views along an axial direction of the auger 59 showing a shape of the vanes of the auger 59. A loading amount of the waste toner per unit length can be increased by reducing an angle 0 of attachment of the vanes to the center shaft. A loading amount of the waste toner per unit length can also be increased by forming a sectional shape of the vanes in a curved surface shape concave in a transfer direction rather than a planar shape.

Intervals of attachment of the auger vanes of the third waste-toner transfer unit 53 may be set wider than intervals of attachment of the auger vanes of the second waste-toner transfer unit 52. A transfer amount of the waste toner per unit time can be increased by setting the intervals of attachment of the auger vanes wider.

The image forming apparatus according to the embodiment explained above includes the waste-toner transfer unit disposed vertically. Therefore, it is possible to effectively use a dead space in an apparatus body in the past and realize an apparatus body excellent in terms of design.

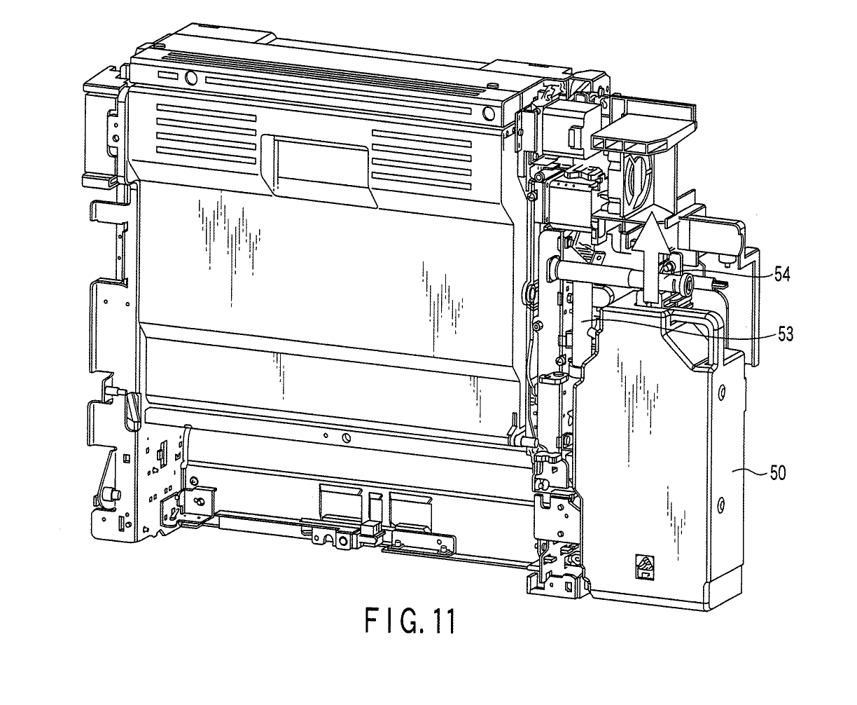

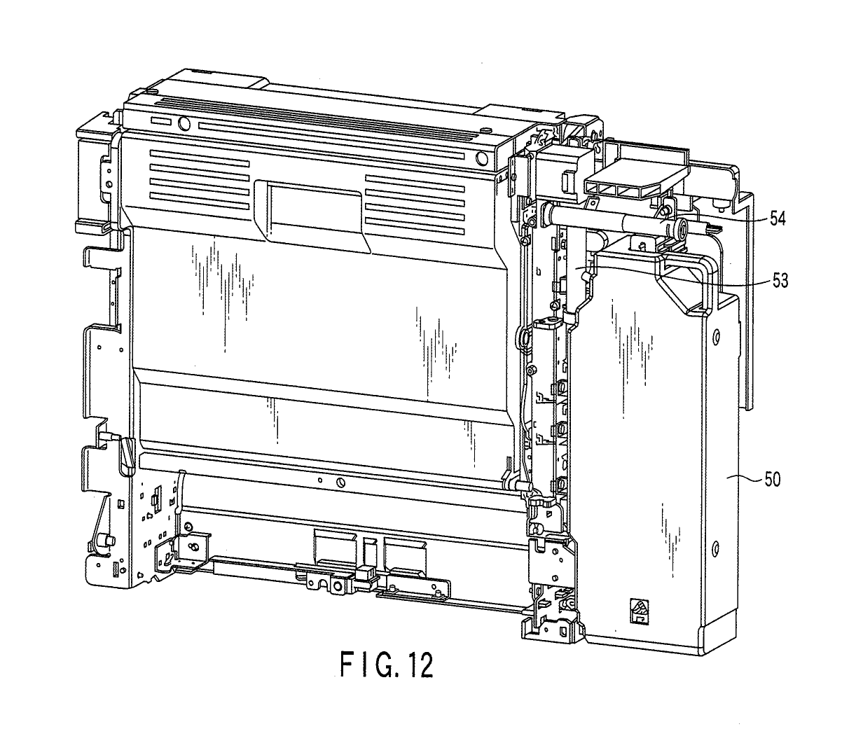

FIGS. 11 and 12 are diagrams showing examples of a configuration of the image forming apparatus according to this embodiment. As shown in FIG. 11, the waste toner box 50 can be disposed in close contact with a main body. Therefore, it is possible to secure a capacity for storing the waste toner without increasing a size of the image forming apparatus. As shown in FIG. 12, by increasing the height of the waste toner box 50, it is possible to increase the capacity for storing the waste toner without increasing a size of the image forming apparatus.

The auger transfer mechanism explained in this embodiment can be used not only for transferring the waste toner but also for transferring a toner or powder. The auger transfer mechanism can be applied not only to the image forming apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A waste-toner transferring device that transfers a waste toner to a waste-toner collecting unit, the waste-toner transferring device comprising:
a first auger transfer unit arranged vertically; and
a second auger transfer unit configured to supply the waste toner to the first auger transfer unit, wherein
the first and second auger transfer units respectively have casings provided with inlets and outlets for the waste toner and augers rotatable around shafts arranged along a transfer direction in the casings, and
auger vanes are not provided in a predetermined range of the auger arranged in a portion of the outlet of the second auger transfer unit, the predetermined range being narrower than the width of the inlet of the first auger transfer unit.

2. A waste-toner transferring device according to claim 1, wherein the predetermined range is wider than an interval of the auger vanes.

3. A waste-toner transferring device according to claim 1, wherein a member that supports an exit side end of the shaft of the second auger transfer unit has an oil seal mechanism.

4. A waste-toner transferring device according to claim 3, wherein a member that supports a lower side end of the shaft of the first auger transfer unit has an oil seal mechanism.

5. A waste-toner transferring device according to claim 1, wherein rotating speed of the auger of the first auger transfer unit is larger than rotating speed of the auger of the second auger transfer unit.

6. A waste-toner transferring device according to claim 1, wherein an attachment angle of the auger vanes to the shaft in a transfer direction of the waste toner on a sectional view along an axis of the auger of the first auger transfer unit is smaller than an attachment angle of the auger vanes to the shaft in a transfer direction of the waste toner on a sectional view along an axis of the auger of the second auger transfer unit.

7. A waste-toner transferring device according to claim 1, wherein an attachment interval of the auger vanes on a sectional view along an axis of the auger of the first auger transfer unit is wider than an attachment intervals of the auger vanes on a sectional view along an axis of the auger of the second auger transfer unit.

8. A waste-toner transferring device according to claim 1, wherein a shape of the auger vanes on a sectional view along an axis of the auger of the first auger transfer unit is concave in a transfer direction of the waste toner.

9. An image forming apparatus comprising:
an image transferring unit configured to transfer a reverse image based on a scanned original image onto an image bearing member as a toner image;
a secondary transfer roller that comes into contact with the image bearing member and transfers the toner image onto a recording medium;
a cleaning device that removes a residual toner on the secondary transfer roller as a waste toner; and
a waste-toner transferring device that transfers the removed waste toner to a waste toner collecting device, wherein
the waste-toner transferring device has a first auger transfer unit arranged vertically and a second auger transfer unit configured to supply the waste toner to the first auger transfer unit,
the first and second auger transfer units respectively have casings provided with inlets and outlets for the waste toner and augers rotatable around shafts arranged along a transfer direction in the casings, and
auger vanes are not provided in a predetermined range of the auger arranged in a portion of the outlet of the second auger transfer unit, the predetermined range being narrower than the width of the inlet of the first auger transfer unit.

10. An image forming apparatus according to claim 9, wherein the predetermined range is wider than an interval of the auger vanes.

11. An image forming apparatus according to claim 9, wherein a member that supports an exit side end of the shaft of the second auger transfer unit has an oil seal mechanism.

12. An image forming apparatus according to claim 11, wherein a member that supports a lower side end of the shaft of the first auger transfer unit has an oil seal mechanism.

13. An image forming apparatus according to claim 9, wherein rotating speed of the auger of the first auger transfer unit is larger than rotating speed of the auger of the second auger transfer unit.

14. An image forming apparatus according to claim 9, wherein an attachment angle of the auger vanes to the shaft in a transfer direction of the waste toner on a sectional view along an axis of the auger of the first auger transfer unit is smaller than an attachment angle of the auger vanes to the shaft in a transfer direction of the waste toner on a sectional view along an axis of the auger of the second auger transfer unit.

15. An image forming apparatus according to claim 9, wherein an attachment interval of the auger vanes on a sectional view along an axis of the auger of the first auger transfer unit is wider than an attachment interval of the auger vanes on a sectional view along an axis of the auger of the second auger transfer unit.

16. An image forming apparatus according to claim 9, wherein a shape of the auger vanes on a sectional view along an axis of the auger of the first auger transfer unit is concave in a transfer direction of the waste toner.

17. An image forming method for an image forming apparatus having an image transferring unit configured to transfer a reverse image based on a scanned original image onto an image bearing member as a toner image, a secondary transfer roller that comes into contact with the image bearing member and transfers the toner image onto a recording medium, a cleaning device that removes a residual toner on the secondary transfer roller as a waste toner, and a waste-toner transferring device that transfers the removed waste toner to a waste toner collecting device, the method comprising;
arranging vertically a first auger transfer unit that is provided in the waste-toner transferring device, and
arranging a second auger transfer unit that supplies the waste toner to the first auger transfer unit, wherein
the first and second auger transfer units respectively have casings provided with inlets and outlets for the waste toner and augers rotatable around shafts arranged along a transfer direction in the casings, and
auger vanes are not provided in a predetermined range of the auger arranged in a portion of the outlet of the second auger transfer unit, the predetermined range being narrower than the width of the inlet of the first auger transfer unit.

18. An image forming method according to claim 17, wherein the predetermined range is wider than an interval of the auger vanes.
